(19) United States
(12) Patent Application Publication
(10) Pub. No.: US 2005/0230228 A1
(43) Pub. Date: Oct. 20, 2005

(54) Touch control switch assembly with digital display for a food heating or warming cabinet

(76) Inventors: John Gerard Smith, Setauket, NY (US); Peter Wesley Grennan, Shirley, NY (US)

Correspondence Address: JAMES R HASSELBECK, 6468 LAKE RD, MILLINGTON, MI, 48746, US

(21) Appl. No.: 11/049,145

(22) Filed: Feb. 3, 2005

Related U.S. Application Data
(60) Provisional application No. 60/563,106, filed on Apr. 19, 2004.

(51) Int. Cl. H01H 13/70

(52) U.S. Cl. 200/5 A

(57) ABSTRACT

A prepared food heating and holding cabinet is provided with an improved touch control switch and digital display assembly. The touch control and display assembly replacing the prior art display which has a membrane switch technology prone to early environmental and thermal failure. The touch control and digital display of the disclosed invention assembly having sealed PC board mounted switches mounted behind a rigid metallic front panel substrate. The front panel having a graphically imprinted polyester overlay which can tolerate relatively harsh temperature environments such as found on a heated food holding cabinet. The polyester overlay providing environmental isolation of the electronics and switches from the oil, grease and steam laden food service environment. The sealed switches providing even further isolation and protection of the electrical switch contacts from the harsh environment. The assembly further designed to provide a low cost parts service alternative to the prior art, wherein the polyester overlay, if it fails, can be replaced along with the substrate without replacing the touch control and display electronics.

### CROSS-REFERENCE TO RELATED APPLICATIONS

This application claims priority to co-pending U.S. Provisional Patent Application having Ser. No. 60/563,106 filed Apr. 19, 2004 entitled “Improved touch control switch assembly with digital display for a food heating or warming cabinet”, having common applicants herewith.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The invention relates generally to the field of touch control switch and display assemblies or panels, and in particular as applied to food service heating and food holding cabinets, and providing a long life touch control switch display for use in a harsh commercial food preparation environment.

### BACKGROUND OF THE INVENTION

In the field of food preparation and food service, it is well known that it is advantageous to utilize a food warming and holding appliance to ensure food quality and food safety. Such food holding cabinets are well known in the food service industry. Certain types of prepared food holding cabinets are known as universal holding cabinets (UHC) by those skilled in the food service appliance art. Varieties of such cabinets, including UHCs, utilize an electronic controller module to monitor temperature sensors and regulate heating elements and other elements to maintain the desired thermal environment for the prepared foods for optimum storage time and quality.

In the restaurant and food service industry, foods are often prepared in advance of the product order and eventual sale to the customer, often for efficiency reasons and to enable a ready supply of prepared product for quick fulfillment of customer orders. The issues of holding the prepared food at a safe temperature, and in an environment designed to extend the food hold time is commonly addressed by placing prepared foods in a hot cases or a heated food holding cabinet. Such cabinets are well known to those in the food service industry. It is well known that it is extremely important to maintain a controlled temperature in such hot cases and holding cabinets. Hot foods need to be held at 140 [degrees] F. or above to be kept safe for human consumption. Keeping food hot isn't the only issue with regard to holding and warming cabinets. Heat is important, but it is equally important that the product not dry out. Many heated holding cabinets and display cases, particularly newer models, offer moisture introduction to provide moist heat in a humidity-controlled cabinet for many food items. Delicate foods keep longer and will not dry out as rapidly in a humid environment. Along with humidity control, some display cases have a forced air glass defogger to prevent condensation build-up. The defogger is an important aid to merchandising, as is lighting.

Beyond introducing moisture to cases and cabinets, the newest generation of units offers variable moisture control technology to maintain food texture. The idea is to keep the water vapor content in the cabinet the same as that of the food. This approach controls moisture evaporation and saturation so crisp foods stay crisp, moist foods stay moist, and soft-textured products and-sauces don't harden. Some holding cabinets utilize humidity controls to maintain a precise amount of moisture in the unit. The moisture can be set and varied, depending upon the optimum holding of the product within. Some manufacturers claim this technology doubles the holding time of many foods.

The sophistication and number of controls and sensors lead to the use of a digital microprocessor based holding cabinet control module to regulate to operation of food holding cabinets. Such microprocessor based controls are often located exterior to holding cabinet, for example on the rear of the cabinet, or in cooler and protected areas of the holding cabinet enclosure. This is advantageous as it tends to isolate the controller module from elevated temperatures and contaminants. The operator interface switch and display panel is often located on the holding cabinet face in a location convenient to the cabinet operator, and is usually connected/interfaced to the digital controller via a ribbon cable and/or other electrical wiring or fiber optic connections.

In embodiment—a holding cabinet may be on wheels, built into a counter, or employed as a stand-alone cabinet. Warmers are available in a range of sizes, utilize some variety of a controlled heating source, and can serve various functions, such as product display, in addition to its food holding function. Lower cost food holding cabinets may be just a stainless steel or aluminum shell cabinet, with minimal or rudimentary thermal controls. Higher-quality, more costly holding cabinets may have insulated walls for better heat retention, and utilize more sophisticated environmental controls, ranging from analog types to more sophisticated microprocessor based digital controllers providing a range of preprogrammed operating modes. Such higher quality cabinets typically provide an operator interface switch and display panel or panels. Such panels provide the operator with a convenient interface to the operation of the holding cabinet controller, and usually include such devices as digital displays (such as LEDs or LCDs), and touch activated switches such as momentary contact. It is problematic that the environment in which such switch and display panels operate is known to be laden with grease, steam and various cleaning solvents, as well as the exposure to the elevated operating temperatures of the holding cabinet itself. These environmental factors reduce the operating life of the switch and display panels, and contribute to the eventual failure of panel touch switches, particularly membrane switches in the prior art.

Some food holding cabinets serve as display cases also and are sometimes available with ‘steps’ inside the case to effectively merchandise product and maximize display area. It is extremely important to maintain a constant proper temperature in food holding cabinets. Hot foods need to be held at 140 [degrees] F. or above to be safe. Generally, maintaining the proper temperature requires bottom heat, as well as top heat to surround the product.

As can be appreciated from the above discussion, food holding cabinets can be quite sophisticated in the use of heating elements, moisture or humidity, and other environmental controls, and food quality monitoring. Such food holding cabinets typically utilize operator interface touch control switch and display panels on an exterior face of the holding cabinet. The environment of the switch and display panel or assembly is particularly challenging in its exposure to elevated temperatures, spills, grease, oil, water vapor, and in the application of cleaning solvents and in perhaps abrasive cleaning practices required to maintain cleanliness in food service. As can be appreciated, prior art food holding cabinet switch and display panels have had less than desirable success in service in these conditions.

### BRIEF SUMMARY OF THE INVENTION

It is therefore the object of the present invention to provide a food holding cabinet switch and display assembly which overcomes most of the problems of the prior art resulting in early switch failure and higher than necessary replacement cost when a switch and display assembly component eventually fails.

It is therefore the primary object of the present invention to provide an improved food service/restaurant prepared food holding cabinet switch and display assembly. Certain types of prepared food holding cabinets are known as universal holding cabinets (UHC) by those in the food service appliance art. As discussed earlier, varieties of such cabinets, including UHCs, utilize an electronic controller module to monitor temperature sensors and regulate heating elements and other elements to maintain the desired environment for the prepared foods. It is typical for such cabinets to use a separately mounted operator input switch and display module mounted through an exposed surface of the food holding cabinet. Such switch and display modules are typically physically separate components from the controller board, but are electrically connected to the controller module, for example via a ribbon cable. In the particular case of a digitally controlled food holding cabinet, the switch and display module provide a means for the operator to enter temperature and time settings and other parameters into the controller module, and to observe displayed operation data and feedback responses provided to the switch and display unit by the controller module. The disclosed invention can be advantageously applied on such food holding cabinets, as well as other appliances used in high temperature and harsh food service environment requiring long service life and benefiting from a switch and display assembly which is easily and inexpensively repairable.

As discussed in the prior art above, it is a common problem that a switch and display assembly operating in the food holding cabinet environment is subject to operating stresses from elevated temperatures, humidity, vapor and liquid phase oils, grease, fat, steam and water as well as other foods as commonly present in a commercial food preparation environment. Additionally abrasions from cleaning procedures, etc. can damage the membrane switch membrane seal, allowing contaminants as well as cleaning agents to enter the switch contact area, resulting in a failure of the switch.

The prior art food holding cabinet switch and display assemblies utilize a membrane switch technology. Membrane switches in general utilize laminations of dielectric film or plastic sheets which have conductive films or metallic conductive paths disposed thereon to provide the electrical contact points of the switch.

Membrane switches are widely used in relatively low power electrical items such as appliances (e.g., microwave ovens, radios and TVs), calculators and computers, and toys. They are the familiar “touch” switches which turn the microwave on and off, for example. There are at least two basic types of membrane switches:
Flat touch panel membrane switches are composed of a polycarbonate overlay with graphics to operate the switch; a top layer with contacts printed on the bottom side, spacer with openings corresponding to the contacts on the top layer, and a bottom layer with circuitry on its top side. Membrane switches of this type include those typically applied in the prior art food holding cabinet switch and display assemblies.
Full travel membrane switches are keyboards used in computers. They are similar to touch panel membrane switches, except that a printed circuit board is employed as the bottom backboard.

Membrane switch technology is often used in food service cabinet applications as it affords a relative low cost switch and provides the benefits of sealing the switch contacts from contaminants in the food service environment. The application of non-sealed conventional switches lacking an environmental seal between the harsh environment and the switch contact are generally not used due to the likelihood of intermittent operation and early failure from ingress of oil and grease from the food preparation environment.

In a membrane switch, as used in the prior art, a spacer layer is used to hold the top and bottom circuits in register and provide a separation that keeps the switch contacts apart until the switch is depressed, the space layer usually consists of a film with a pressure-sensitive adhesive on both sides. The film must be die cut, bond well, and move along with the circuit film in response to changes in temperature and humidity. It is known in the art that films that do not have the same thermal and hygroscopic expansion coefficients will not move the same as the circuit film and will cause the adhesive to be displaced and interfere with the operation of the switch. The tendency for displacement between film layers is aggravated by the elevated operating temperature of the food holding cabinet.

The subject food cabinet switch assembly of this invention is a replacement for and improvement over the prior art membrane switch technology applied to food holding cabinets as discussed above. The disclosed assembly includes a polyester membrane permanently and sealably bonded to a stainless steel or other suitable rigid and supportive substrate. Polyester material is a bi-axialy oriented polyethylene terephthalate film, sometimes called PET. The PET membrane may be sealably bonded to the substrate using a known high performance laminating adhesive such as 3M corporations 200MP chemistry, or any other suitable high performance laminating adhesive product.

In addition to its long life and sealing properties, the polyester sheet overlay can be embossed to obtain prominent shapes such as key surrounds, full keys or dots on keys for ease of touch location, as well as lines or curves to enhance the design and identify function to the operator. It is known to those skilled in polyester overlay graphics art that matte finish areas along with selected transparent areas having a clear glossy finish can be provided on the same polyester sheet. The present invention utilizes this technology to provide a polyester sheet having a matte finish, also having transparent windows embedded through which the operator may view information presented on the digital display devices, while the switches and electronics remain protected and isolated from the food service environment behind the substrate face panel and the protective polyester overlay.

The preferred embodiment of the food cabinet switch assembly of this invention is provided with a removably attached printed circuit board having directly mounted light emitting diode (LED) displays, and a plurality of directly mounted sealed mechanical switches, as well as ribbon cables, and connectors as required to provide the direct replacement functionality for the prior art switch and display assembly. It should be obvious that LCD displays, fluorescent displays as well as other display technologies known to those skilled in the art may be substituted for the LED display discussed herein without deviating from the intent and disclosure of this invention. Said printed circuit board having a fixed distal coplanar and facing relationship to the stainless steel substrate. The substrate also serves as a mounting means and support means as well as a further environmental barrier protecting the printed circuit display board and the electronic components mounted thereon.

The switch and display assembly substrate of the invention is provided with a plurality of holes punched though to provide mechanical contact between the head of a PC board mounted, sealed mechanical switch and the backside of the polyester membrane, providing a switch actuation hot spot on the membrane. This polyester membrane is provided on the outside facing surface of the substrate and can be provided with screened identifying markings and a domed raised form. The domed raised form on the polyester sheet further identifies the switch head active region behind the polyester overlay to the operator and further providing a screened graphic icon display of its function.

Prior art food holding cabinet switch and display assemblies utilize a membrane switch technology that lacks a tactile feedback of switch operation to the operator. It is an object of the invention to provide the user with a tactile feedback of switch operation. The sealed PC board mounted switches providing said tactile feedback of the switch operation through the-polyester membrane. The tactile feedback is provided by an inherent function of the sealed mechanical switch. Sealed mechanical switches providing a tactile feedback, designed to mount to a printed circuit board and having a suitable protruding actuator as utilized in the present invention are well known in the art, and are available from multiple electronic component manufacturers, including for example Grayhill and Alsoswitch.

It is another object of the invention that the polyester overlay further isolates the switches from exposure to grease, oil, dirt and other contaminants in the operating environment. The polyester membrane is securely and permanently bonded to the substrate, the bonding further providing a seal between contaminants in the environment and the switch and PC board components.

It is another object of the invention to provide a food holding cabinet and UHC replacement switch and display having a longer service life in the field than the prior art. The polyester sheet of the present invention has been shown through factory tests to provide over 1.1 million actuation cycles without failure, providing a superior operating life over the prior art in a harsh food service environment.

It is another object of the invention to provide a food holding cabinet display switch assembly which overcomes the general problem of de-lamination with substantial fluid ingression as present in prior art membrane switches. Problems with membrane switch de-lamination and failure are well known, and are known to be prone to early failure when membrane switches are used in high temperature environments, say in a food holding cabinet or a universal holding cabinet in the presence of steam and oil. It is known by the inventors and other users of prior art UHC display devices that in operation over time, it appears that grease/steam penetrates the layers of the membrane switch overlay, and the switch operation degrades, requiring repeated activation and greater activation pressure in order to operate. Eventually the switch can electrically open altogether and becomes unusable. It is an object of the present invention to overcome this limitation in the prior art with a UHC replacement switch and display board assembly by using sealed PC board mechanical switches mounted behind a polyester overlay, said overlay and sealed mechanical switches replacing the front panel membrane switch technology of the prior art and thereby overcoming the de-lamination and fluid ingression switch failure problem.

It is a further object of the invention to provide a food holding cabinet switch and display assembly which provides a reduced repair and replacement cost over the prior art. The present invention's polyester overlay completely avoids the use of embedded membrane switches as in the prior art and thereby achieves a longer service life for the reasons discussed earlier. As all components eventually fail in service, the present invention provides a front panel substrate with polyester overlay that is an inexpensive item that can be replaced independently of the switch, LED display printed circuit board assembly. This makes it unnecessary to discard the entire assembly. This feature reduces replacement cost, thereby providing a significant monetary savings to the end user, and reduces the environmental concerns and issues from the leaching into the environment of any chemicals present in what may be otherwise discarded electronic boards and components, as is the case in the prior art display board design.

Membrane switch de-lamination is well known. www.bergquistcompany.com has a discussion of the general problem of de-lamination with substantial fluid ingression in membrane switches. De-lamination can be hasten by exposure to oils and chemicals which are absorbed into the plastic of the membrane switch, causing it to become rubbery.

Many membrane switches, while having storage temperatures to 70 or 80 Celsius, many have upper operating temperature limits between 40 to 50 Celsius. In the article, “The Battle over Switch Overlay Films”, Michael Suchocki discloses that the continuous service temperature for PET film such as in the subject invention is between −70 Celsius (−94 Fahrenheit) to 150 Celsius (302 Fahrenheit). Additionally, the above article discloses that “PET absorbs more that 2 times as much water than polycarbonate films. What does this mean? PET provides greater resistance to the transmission of gasses and vapors that may have an adverse effect on the operation of the device.” Mr. Suchocki later summarizes that “High reliability in an aggressive environment for millions of actuations =PET”.

It is well known by those knowledgeable in the art of control and display switch panels for appliances used in relatively high temperature environments that membrane type switches, such as those currently used in the prior art design suffer from early failures. U.S. Pat. No. 4,894,493 to Smith, et al. discloses, among other things: “Membrane touch switch arrays, which have substantially less system cost than capacitive touch pad arrays, are used in refrigerator, dishwasher, microwave ovens, and laundry appliances which provide a less harsh temperature environment, since materials conventionally used in membrane touch switch arrays do not tolerate high temperatures well”.

A further limitation of membrane switch technology is that membrane switches as a group consist of normally open, momentary, single throw switches. It is an another object of the invention disclosed herein to provide the designer with the option to apply other switch characteristics to the control panel design, such as normally closed, with multiple contacts and mechanically latched or retentive switch behavior such as press once to close and press again to open.

Further advantages of the present invention can be appreciated by reading the descriptions, claims and review of the drawings that follow.

### BRIEF DESCRIPTION OF THE DRAWINGS

The drawings show a form of the invention which is presently preferred, however the invention is not limited to the precise arrangement shown in the drawings.

FIG. 1 is a front view (not to scale) of a preferred embodiment food holding cabinet switch and display assembly incorporating features of the invention.

FIG. 2 is an enlarged detail (not to scale) of a portion of the polyester membrane covering the front substrate shown in FIG. 1 and incorporating features of the invention.

FIG. 3 is a top view (not to scale) of a food holding cabinet switch and display assembly incorporating features of the invention. The view is looking down along the edges of the polyester membrane, the substrate and the printed circuit board.

FIG. 4 and FIG. 5 comprise an assembly view (not to scale) of a food holding cabinet switch and display assembly incorporating features of the invention. FIG.4 shows the rear or inward face of the front panel substrate, positioned for better understanding and presentation of features of the invention. FIG. 5 presents an edge view of the printed circuit board, aligned side to side with the substrate, although rotated to present edge on for better illustration of features of the invention.

### DETAILED DESCRIPTION OF THE INVENTION

A front view exemplary food holding cabinet switch and display assembly 13 incorporating features of the invention is shown in FIG. 1 . Polyester membrane sheet 2 is provided with one or more touch switch activation hot spots 4. The hot spots are provided with graphics imprints to identify touch activation location and function to an operator. The single piece polyester sheet may be provided with one or more transparent windows 8 permitting an operator to view information displayed on one or more electronic digital displays 3 through the polyester membrane sheet. As the polyester sheet is continuous and unbroken, the polyester sheet provides an environmental seal between the switches and electronics mounted behind the polyester sheet and substrate, and contaminants typically encountered in a food preparation and food service environment as present around the exterior of the holding cabinet. The touch switch activation hot spots 4 may be provided with an embossed outwardly convex dome feature, or an embossed ridge key surround to further aid an operator in identifying the touch switch location on the polyester membrane.

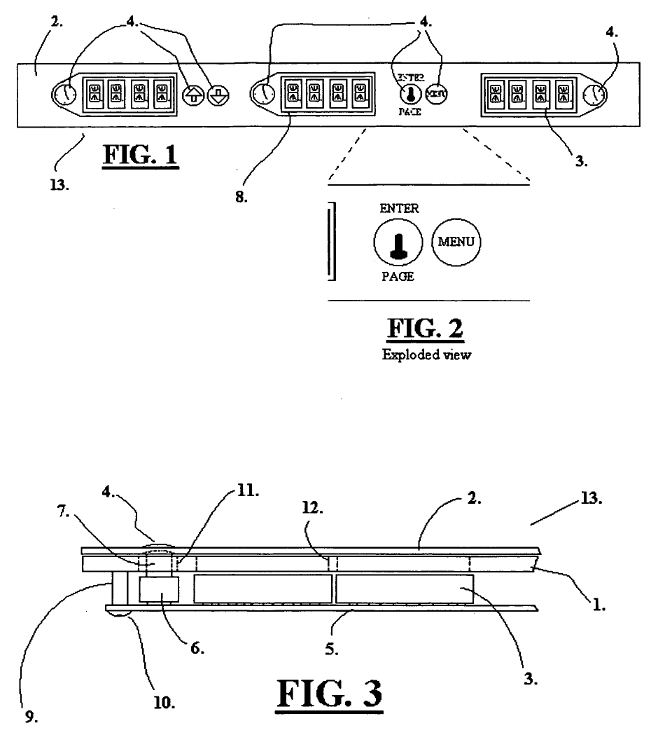

FIG. 2 is an exploded detail of a portion of FIG. 1, further illustrating typical graphic imprints provided on the polyester membrane to identify touch switch location and function an operator. As can be appreciated, the touch switch is located behind the polyester membrane, and the membrane is typically provided with a dyed matte finish which obscures the switch location behind the polyester sheet, and so it is advantageous to utilize domed or ringed hot spots and graphic imprints to guide the operator.

FIG. 3 is a top view. Polyester membrane sheet 2 is securely and sealably bonded to the front face of the rigid and supportive front panel substrate 1. In the preferred embodiment, the substrate is a substantially rigid stainless steel sheet. Polyester membrane sheet 2 is provided with one or more touch switch ‘hot spots’ 4. In the preferred embodiment the switch hot spots include an embossed raised convex dome. A printed circuit board securely mounts and retains one or more sealed mechanical switches 6. The switch actuator member 7 protrudes through an appropriately sized and aligned hole 11 in the substrate 1 to contact the backside of the ‘hot spot’ on the polyester membrane sheet 2. An operator actuates the switch by applying moderate pressure on the hot spot, deflecting the polyester membrane and compressing the switch actuator. The mechanical switch compresses to an actuation point, wherein the switch contacts change state, for example from open to closed, and the switch then provides a tactile feedback to the operator through the switch actuator member and polyester membrane. Various embodiments of the present invention may contain one or more sealed mechanical switches 6, and optionally one or more electronic digital display devices 3. Electronic digital display devices are aligned with display cutouts in the front panel substrate, wherein the substrate cutouts are suitably sized to allow the display to be viewed through the cutout. The polyester membrane sheet 2 is provided with transparent windows positioned directly over the electronic digital displays and substrate display cutouts as shown and discussed in FIG. 1 above.

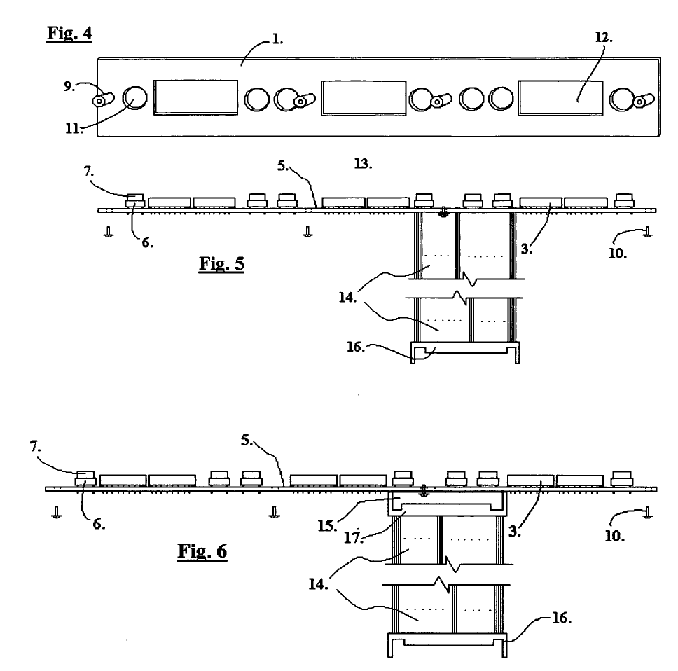

FIG. 4 and FIG. 5 viewed together provide an assembly view of a preferred embodiment of a food holding cabinet switch and display assembly 13 incorporating features of the invention. The printed circuit board 5 containing electronic components including switches 6 and displays 3 is removably aligned with and spaced from the front panel substrate 1 by use of tubular mounting standoffs 9. The printed circuit board is removably attached to the standoffs and the substrate by screws or fasteners 10, providing important cost saving and environmental advantages over the prior art in enabling repair without replacing the entire unit. Standoffs are provided in proximity to switches as necessary to provide support for the printed circuit board. The switch and display assembly 13 includes a multi-conductor interconnect ribbon cable 14. In the preferred embodiment, one end of the ribbon cable is fixedly attached to and electrically soldered to appropriate locations on the screened or etched metallic electrical conductors that provides the electrical interconnection between components mounted to the printed circuit board, while the other end of the ribbon cable is provided with a quick connect/disconnect connector 16. The quick connect/disconnect connector 16 facilitates quick electrical disconnection and removal of the switch and display assembly from the food holding cabinet when repair or replacement becomes necessary. The quick connect/disconnect connector is mechanically attached to the ribbon cable and electrically connected to the conductors of the ribbon cable. The ribbon cable serves to conduct electric power to and electronic signal connections and communication between the switch and display electronics and the food holding cabinet control electronics. Those skilled in the art will recognize that the ribbon cable may be replaced with another type of multi-conductor cable, for example a cylindrical multi-conductor shielded cable, or the use of a plurality of single conductor and multi-conductor interface cables and connectors without deviating from the present invention.

FIG. 6 presents an alternate embodiment of the PC board and ribbon cable interconnection presented earlier in FIG. 5. In the alternate embodiment presented in FIG. 6 the PC board is provided with a interconnect cable receiving member or receptacle 15 designed to removably mate with and electrically interconnect to the quick connect/disconnect connector 17 on the ribbon cable, further facilitating quick removal for repair or replacement.

1. An improved touch control switch and display assembly of the type designed as an operator interface for a food holding cabinet, the assembly comprising:
(a) a rigid front panel substrate sheet having a plurality of holes, said substrate having a front face and a rear face;
(b) a polyester membrane having a front face and a rear face wherein said polyester membrane rear face is secured and sealably adhered to the front face of said substrate, the membrane having a plurality of touch control hot spots, wherein the polyester membrane and substrate form an environmental barrier to ingression of fluids and vapors through said membrane and substrate;
(c) a printed circuit board secured to the rear face of said substrate; and
(d) a plurality of sealed mechanical switches mounted to said printed circuit board, said switches having an actuator member, said front panel substrate holes sized and positioned to allow said actuator member to protrude through the substrate and mechanically contact said hot spots on said polyester membrane.

2. The improved touch control switch and display assembly of claim 1, wherein said substrate includes a readily detachable means for removably securing said printed circuit board to the rear face of said substrate, whereby the polyester membrane and substrate may be replaced independently from the printed circuit board.

3. The improved touch control and switch assembly of claim 2, wherein the readily detachable means comprises a plurality of mounting standoffs secured to the rear face of said substrate, said circuit board having holes sized and positioned to align with said mounting standoffs, a plurality of screws inserted through holes in said printed circuit board and threadably and removably engaged into said mounting standoffs.

4. The improved touch control switch and display assembly of claim 3, wherein said printed circuit board includes metallic electrical conductors secured to the circuit board, wherein at least one interface cable is provided having one or more conductors, the interface cable having a near and far end, wherein the wherein the electrical conductors of the near end of the interface cable are fixedly soldered and secured to metallic electrical conductors of said printed circuit board, wherein the interface cable far end includes at least one electrical quick connect connector member, the quick connect connector sized and fitted to receive and electrically interconnect to a mating electrical receiving connector member of a food holding cabinet.

5. The improved touch control switch and display assembly of claim 2 wherein the sealed mechanical switches provide a tactile feedback of switch operation.

6. The improved touch control switch and display assembly of claim 5 wherein said sealed mechanical switches are selected from the group consisting of momentary normally open, momentary normally closed, mechanically latched retentive.

7. The improved touch control switch and display assembly of claim 3, wherein said printed circuit board is provided with at least one multi-conductor interface cable quick connect connector, the connector securely mounted to said printed circuit board, the connector sized and fitted to receive and electrically connect to a mating quick connect connector member on an end of a multi-conductor electronic interface cable.

8. The improved touch control switch and display assembly of claim 5 wherein the polyester membrane has one or more transparent windows, wherein one or more electronic digital display devices is mounted to said printed circuit board in a facing alignment with said substrate, wherein said one or more holes in said substrate are sized and positioned to align with and expose said digital display devices for viewing, wherein said polyester sheet is provided with one or more transparent regions, said regions sized and positioned to overlay said digital display devices providing a transparent window in said polyester sheet for viewing said digital displays through said front face of said polyester sheet.

9. The improved touch control switch and display assembly of claim 4 wherein the sealed mechanical switches provide a tactile feedback of switch operation, wherein the polyester membrane has one or more transparent windows, wherein one or more electronic digital display devices is mounted to said printed circuit board in a facing alignment with said substrate, wherein said one or more holes in said substrate are sized and positioned to align with and expose said digital display devices for viewing, wherein said polyester sheet is provided with one or more transparent regions, said regions sized and positioned to overlay said digital display devices providing a transparent window in said polyester sheet for viewing said digital displays through said front face of said polyester sheet.
